(19) United States
(12) Patent Application Publication
(10) Pub. No.: US 2016/0381257 A1
(43) Pub. Date: Dec. 29, 2016

(54) SPHERE PANORAMA IMAGE CAPTURING DEVICE

(71) Applicant: ASUSTeK COMPUTER INC., Taipei City (TW)

(72) Inventor: Chun-Liang Kuo, Taipei City (TW)

(21) Appl. No.: 15/188,987

(22) Filed: Jun. 22, 2016

(30) Foreign Application Priority Data
Jun. 29, 2015 (TW) 104120973

(51) Int. Cl. H04N 5/225; H04N 5/232; H04N 13/02

(52) U.S. Cl. CPC H04N 5/2252; H04N 13/0242; H04N 5/23238; H04N 5/2253

(57) ABSTRACT

A sphere panorama image capturing device including an outer sphere, an inner sphere, a plurality of 3D image capturing modules and an orientation sensing module is provided. The outer sphere is transparent. The inner sphere is disposed inside the outer sphere. The inner sphere and the outer sphere have a distance therebetween and the inner sphere is rotatable relative to the outer sphere. The 3D image capturing modules are fixed on the inner sphere. An area of the inner sphere that corresponds to the 3D image capturing module is transparent. The orientation sensing module is disposed on the inner sphere.

### CROSS-REFERENCE TO RELATED APPLICATION

This application claims the priority benefit of Taiwan application serial No. 104120973, filed on Jun. 29, 2015. The entirety of the above-mentioned patent application is hereby incorporated by references herein and made a part of specification.

### BACKGROUND OF THE INVENTION

Field of the Invention

The invention relates to an image capturing device and, more specifically, to a sphere panorama image capturing device.

Description of the Related Art

Conventionally, panoramic photography is obtained by rotating a single camera by 360 degrees to capture images and then stitch the captured images by an image processing. However, a panorama image by this way is limited by a two-dimensional space. A whole scene (for example, sky or ground) above or below the photographic area could not be captured in one image.

### BRIEF SUMMARY OF THE INVENTION

According to a first aspect of the present disclosure, a sphere panorama image capturing device, comprises: an outer sphere which is transparent; an inner sphere disposed inside the outer sphere, wherein the inner sphere and the outer sphere have a distance therebetween and the inner sphere is rotatable relative to the outer sphere; a plurality of three-dimensional (3D) image capturing modules fixed on the inner sphere, wherein an area of the inner sphere that corresponds to the 3D image capturing modules is transparent; and an orientation sensing module disposed on the inner sphere.

In sum, in the embodiments of the sphere panorama image capturing device, the 3D image capturing modules are fixed on the inner sphere. The viewing angle of the 3D image capturing modules is omnidirectional so that the images taken by the 3D image capturing modules are 3D panorama images. The orientation sensing module is configured to the inner sphere to maintain the angle of the inner sphere relative to the outer sphere. The inner sphere is disposed inside the outer sphere. The magnetic repulsive force or the ball bearing between the inner sphere and the outer sphere maintains the inner sphere and the outer sphere spaced apart and rotated relative to one another. Therefore, when the sphere panorama image capturing device is in use, although the outer sphere is rotating (for example, the outer sphere is rotating in the air or on the ground), the inner sphere maintains in the particular angle relative to the outer sphere. Consequently, the 3D image capturing modules 130 takes the image more stably.

### BRIEF DESCRIPTION OF THE DRAWINGS

These and other features, aspects and advantages of the invention will become better understood with regard to the following embodiments and accompanying drawings.

FIG. 1 is a schematic diagram showing a sphere panorama image capturing device in an embodiment.

FIG. 2 is a schematic diagram showing some components of the sphere panorama image capturing device in FIG. 1 in an embodiment.

FIG. 3 is a schematic diagram showing 3D image capturing modules disposed at an inner sphere of a sphere panorama image capturing device in an embodiment.

FIG. 4 is a schematic diagram showing a sphere panorama image capturing device in an embodiment.

### DETAILED DESCRIPTION OF THE EMBODIMENTS

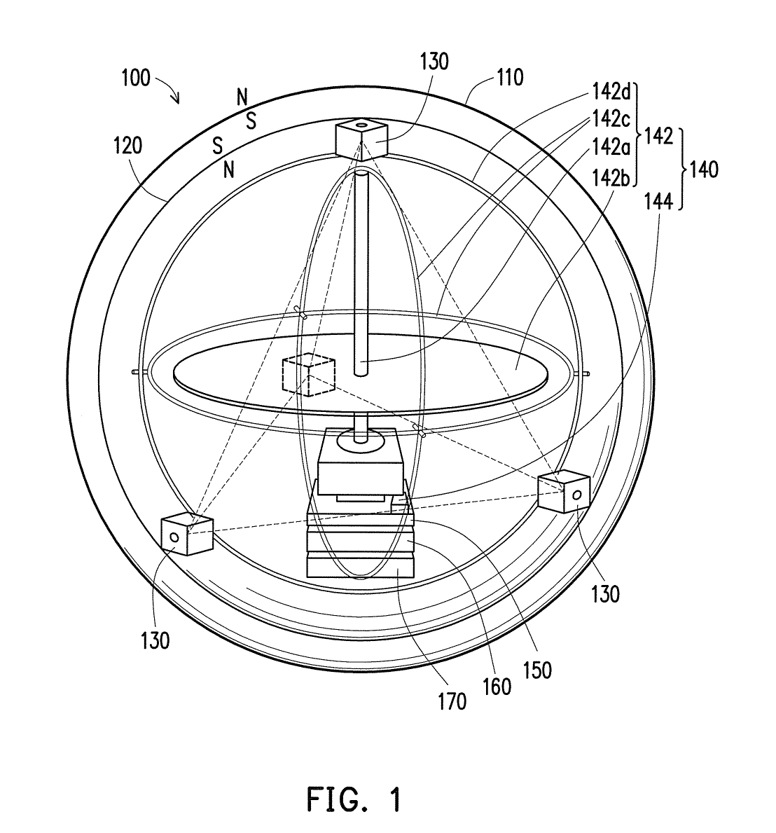

FIG. 1 is a schematic diagram showing a sphere panorama image capturing device in an embodiment. Referring to FIG. 1, in the embodiment, a sphere panorama image capturing device 100 includes an outer sphere 110, an inner sphere 120, a plurality of three-dimensional (3D) image capturing modules 130, an orientation sensing module 140, a circuit module 150, a battery module 160 and a counterweight block 170.

In the embodiment, the inner sphere 120 is disposed inside the outer sphere 110. The outer sphere 110 is spaced apart from the inner sphere 120 by a distance. In the embodiment, the outer sphere 110 and the inner sphere 120 are transparent. In an embodiment, the outer sphere 110 and the inner sphere 120 are formed of transparent reinforced glass or reinforced plastic that are mixed with magnetic powder (for example, iron powder). An inner surface of the outer sphere 110 and an outer surface of the inner sphere 120 have same magnetic polarity, so that the outer sphere 110 and the inner sphere 120 maintain apart due to the magnetic repulsive force. Due to the outer sphere 110 and the inner sphere 120 are not contacted directly, the inner sphere 120 rotates relatively without any disturbance from the outer sphere 110.

The 3D image capturing modules 130 are disposed at the inner surface of the inner sphere 120. In the embodiment, each 3D image capturing module 130 includes an image sensor (not shown) and a field depth sensor (not shown) that operate cooperatively when a 3D image is taken. In the embodiment, the 3D image capturing modules 130 are capable of taking a clear image from a distance of at least eight meters away. In an embodiment, the distance between the image capturing device and the object can be changed according to different 3D image capturing modules 130, which is not limited herein.

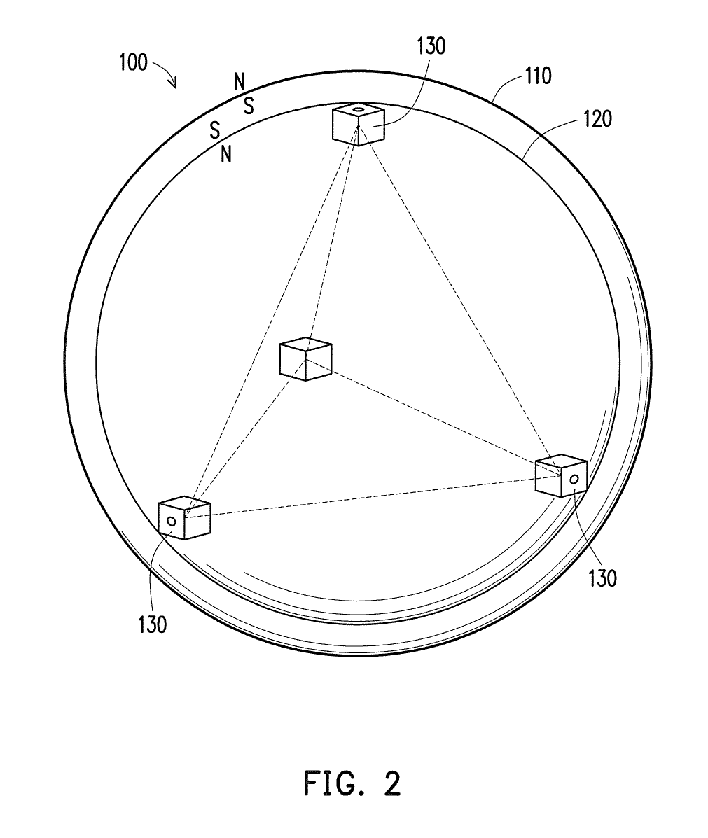

In order to take an omnidirectional 3D image, which includes a scene above/below a photographic area except for a horizontal view which is captured by rotating a camera 360 degrees, the 3D image capturing modules 130 are arranged as following. FIG. 2 is a schematic diagram showing some components of the sphere panorama image capturing device in FIG. 1 in an embodiment. In FIG. 2, to clearly show the locations of the 3D image capturing modules 130, only the outer sphere 110, the inner sphere 120 and the 3D image capturing modules 130 of the sphere panorama image capturing device 100 are shown schematically, other components of the sphere panorama image capturing device 100 are omitted. As shown in FIG. 2, in the embodiment, four 3D image capturing modules 130 are illustrated for example. Lines through any two of the 3D image capturing modules 130 disposed at the inner sphere 120 form a regular triangular pyramid where the 3D image capturing modules 130 are located at the four vertexes, respectively. In the embodiment, each of the 3D image capturing modules 130 is capable of taking an image within a wide angle of at least 120 degrees. In this way, the 3D image capturing modules 130 located at the vertexes of the regular triangular pyramid can take a 360-degree panorama image.

In the embodiment, the inner sphere 120 is transparent so that the 3D image capturing modules 130 are capable of capturing the images of the objects outside the inner sphere 120 and the outer sphere 110. In other embodiments, only the areas of the inner sphere 120 that correspond to the 3D image capturing modules 130 is transparent to obtain the 3D image capturing modules 130 in a required wide-angle field.

Back to FIG. 1, the orientation sensing module 140, the circuit module 150 and the battery module 160 are disposed inside the inner sphere 120 and are fixed on the inner sphere 120. In the embodiment, the orientation sensing module 140 is electrically connected to the circuit module 150. The orientation sensing module 140 provides a sensing data to the circuit module 150 for signal processing. The battery module 160 is electrically connected to the circuit module 150, the 3D image capturing modules 130 and the orientation sensing module 140 to provide power.

In the embodiment, the orientation sensing module 140 includes a gyroscope 142 and an accelerometer 144. The accelerometer 144 detects an acceleration data of the inner sphere 120. The gyroscope 142 detects an angular velocity data of the inner sphere 120 and maintains the direction of the inner sphere 120 relative to the outer sphere 110. The acceleration data detected by the gyroscope 142 and the angular velocity data detected by the accelerometer 144 are provided to the circuit module 150. The gyroscope 142 includes a shaft lever 142a, a rotor 142b, a gimbal element 142c and an outer frame 142d. The rotor 142b rotates around the shaft lever 142a. In the embodiment, the gimbal element 142c includes an inner ring and an outer ring. The inner ring is connected to the shaft lever 142a and rotates together with the shaft lever 142a. A first shaft is connected pivotally between the inner ring and the outer ring. A second shaft is connected pivotally between the outer ring and the outer frame 142d. When the rotor 142b rotates, the gyroscope 142 maintains the direction of the inner sphere 120 s based on the law of conservation of angular momentum. The sphere panorama image capturing device 100 maintains the inner sphere 120 in a particular angle relative to the outer sphere 110 via the orientation sensing module 140. Therefore, when the sphere panorama image capturing device 100 is in use, the inner sphere 120 still maintains its orientation relative to the outer sphere 110 even the outer sphere 110 rotates (for example, the outer sphere 110 rotates in the air or on the ground). As a result, the 3D image capturing modules 130 takes the image more stably.

In the embodiment, except the orientation sensing module 140, the circuit module 150 and the battery module 160 are configured at a lower position inside the inner sphere 120, for example, near the bottom of the inner sphere 120. The inner sphere 120 relocates to its original place like a tumbler by configuring the heavier components at the lower position inside the inner sphere 120 (to lower the whole gravity center). For example, the inner sphere 120 relocates to a position where the bottom surface of the regular triangular pyramid formed by the arrangement of the 3D image capturing modules 130 is in a horizontal plane.

In the embodiment, the counterweight block 170 is further configured at the lower position inside the inner sphere 120, which lowers the gravity center of the inner sphere 120 in another way. In an embodiment, the battery module 160 is also a good component to make the gravity center of the inner sphere 120 lower. In an embodiment, other functional modules (such as, a memory module and a wireless transmission module) or built-in components also can be configured inside the inner sphere 120 to keep the gravity center of the inner sphere 120 lower, and then the counterweight block 170 is eliminated.

In the embodiment of the sphere panorama image capturing device 100, the 3D image capturing modules 130 are fixed on the inner sphere 120, the visual angle of the 3D image capturing modules 130 covers 360 degrees to capture an omnidirectional 3D image. The orientation sensing module 140 is used to maintain the inner sphere 120 in the particular orientation, the outer sphere 110 is capable of rotating relatively to the inner sphere 120, therefore, when the outer sphere 110 is moved by touch, hit or threw, the inner sphere 120 maintains in the particular orientation relative to the outer sphere 110. Thus, the 3D image capturing modules 130 takes the image more stably. The sphere panorama image capturing device 100 in the embodiment provides an omnidirectional 3D image data, which can be applied to measurement of 3D images, virtual reality technology, environment identification of intelligent robots, observation and monitoring systems, military reconnaissance systems and the like.

In the embodiment, the way of configuring the 3D image capturing modules 130 to the inner sphere 120 is exemplified. In other embodiments, the number of the 3D image capturing modules 130 and the arrangement of the 3D image capturing modules 130 on the inner sphere 120 can be various according to practical usages, which is not limited herein.

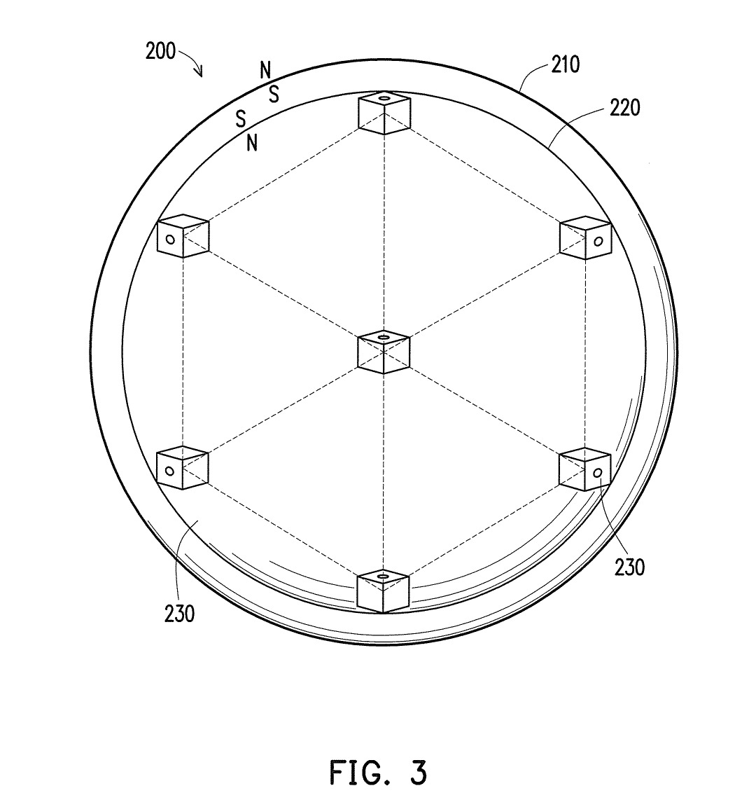

FIG. 3 is a schematic diagram showing a 3D image capturing module disposed at an inner sphere of a sphere panorama image capturing device in an embodiment. Referring to FIG. 3, in the embodiment, a sphere panorama image capturing device 200 is configured with eight 3D image capturing modules 230 (only seven 3D image capturing modules 230 are shown in FIG. 3 from the visual angle). Lines through any two of the 3D image capturing modules 230 on the inner sphere 220 form a cube where the 3D image capturing modules 230 are located at eight vertexes. Each of the 3D image capturing modules 230 is capable of taking an image within a wide angle of at least 90 degrees so that the 3D image capturing modules 230 at the eight vertexes of the cube are capable of taking a 360-degree panorama image. In an embodiment, the 3D image capturing modules 230 are arranged in a cuboid or other stereo shape, which is not limited herein.

In an embodiment, the number and the arrangement of the 3D image capturing modules 130, 230 can be various according to selected 3D image capturing modules 130, 230 with different angle ranges. For example, if the 3D image capturing modules 130, 230 can capture images in a wider angle range, the number of the 3D image capturing modules 130, 230 can be reduced accordingly. In an embodiment, only three or even two 3D image capturing modules 130, 230 are arranged in a same plane, instead of arranged to form a stereo shape.

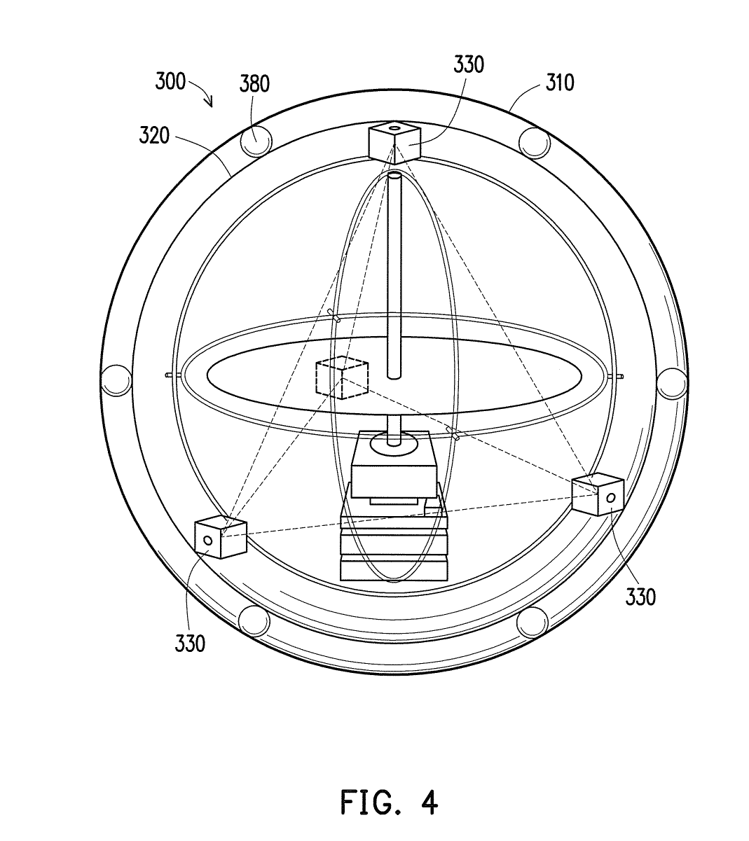

FIG. 4 is a schematic diagram showing a sphere panorama image capturing device in an embodiment. Referring to FIG. 4, in the embodiment, the difference between a sphere panorama image capturing device 300 and the sphere panorama image capturing device 100 in FIG. 1 is described hereinafter. In the embodiment of FIG. 1, the magnetic repulsive force between the outer sphere 110 and the inner sphere 120 maintains the outer sphere 110 and inner sphere 120 spaced apart. In the embodiment of the sphere panorama image capturing device 300 in FIG. 4, a plurality of ball bearings 380 configured between an outer sphere 310 and an inner sphere 320 allows the outer sphere 310 and the inner sphere 320 to be spaced apart by a distance and to rotate relatively. In the embodiment, the ball bearings 380 are transparent. In another embodiment, the ball bearings 380 are not transparent and are restricted at a particular position between the outer sphere 310 and the inner sphere 320 to avoid the ball bearings 380 shade the 3D image capturing modules 330.

In the embodiments of the sphere panorama image capturing device, the 3D image capturing modules are fixed on the inner sphere. The viewing angle of the 3D image capturing modules is omnidirectional, and thus the 3D image capturing modules can take omnidirectional 3D images. The orientation sensing module is configured to the inner sphere to maintain the angle of the inner sphere relative to the outer sphere. The inner sphere is sheathed with the outer sphere. The magnetic repulsive force or the ball bearing between the inner sphere and the outer sphere maintains the inner sphere and the outer sphere spaced apart and the inner sphere and the outer sphere rotate relatively. Therefore, when the sphere panorama image capturing device is in use, although the outer sphere rotates (for example, the outer sphere rotates in the air or on the ground), the inner sphere maintains in the particular orientation relative to the outer sphere. Consequently, the 3D image capturing module takes the image more stably.

Although the invention has been disclosed with reference to certain preferred embodiments thereof, the disclosure is not for limiting the scope. Persons having ordinary skill in the art may make various modifications and changes without departing from the spirit and the scope of the invention. Therefore, the scope of the appended claims should not be limited to the description of the preferred embodiments described above.

What is claimed is:

1. A sphere panorama image capturing device, comprising:
an outer sphere which is transparent;
an inner sphere disposed inside the outer sphere, wherein the inner sphere and the outer sphere have a distance therebetween and the inner sphere is rotatable relative to the outer sphere;
a plurality of three-dimensional (3D) image capturing modules fixed on the inner sphere, wherein an area of the inner sphere that corresponds to the 3D image capturing modules is transparent; and
an orientation sensing module disposed on the inner sphere.

2. The sphere panorama image capturing device according to claim 1, wherein the number of the 3D image capturing modules is at least four and the 3D image capturing modules are located at vertexes of one polyhedron.

3. The sphere panorama image capturing device according to claim 2, wherein the polyhedron is a regular triangular pyramid, a cube or a cuboid.

4. The sphere panorama image capturing device according to claim 1, wherein an inner surface of the outer sphere and an outer surface of the inner sphere have a same magnetic polarity.

5. The sphere panorama image capturing device according to claim 1, further comprising:
a circuit module fixed on the inner sphere, wherein the orientation sensing module and at least one of the 3D image capturing modules are electrically connected to the circuit module.

6. The sphere panorama image capturing device according to claim 5, further comprising:
a battery module fixed on the inner sphere closely to the circuit module and electrically connected to the circuit module.

7. The sphere panorama image capturing device according to claim 1, further comprising:
a counterweight block fixed on the inner sphere.

8. The sphere panorama image capturing device according to claim 1, wherein the orientation sensing module includes a gyroscope and an accelerometer.

9. The sphere panorama image capturing device according to claim 1, wherein the inner sphere is transparent.

10. The sphere panorama image capturing device according to claim 1, further comprising a plurality of ball bearings disposed between the outer sphere and the inner sphere.
